(19) United States
(12) Patent Application Publication
(10) Pub. No.: US 2004/0220052 A1
(43) Pub. Date: Nov. 4, 2004

(54) Water gas shift reaction catalysts

(75) Inventor: Chunzhi He, Westfield, NJ (US)

Correspondence Address: Bright Instruments Corp., 23 Clearview Drive, Mansfield, CT, 06250, US

(73) Assignee: Bright Instruments Corp., Mansfield, CT

(21) Appl. No.: 10/426,069

(22) Filed: Apr. 29, 2003

(51) Int. Cl. B01J 23/652

(52) U.S. Cl. 502/313

(57) ABSTRACT

The present invention discovered a new type of water gas shift reaction catalysts. A catalyst of this type comprises a catalyst support and two catalytically active components. The catalyst support is a high surface area material, such as silicon oxide, aluminum oxide, or carbon power. The two catalytically active components are a metal oxide component and a metal component. The said metal oxide component is molybdenum oxide. The said metal component can be either a noble metal selected from Pt, Pd, Ru, Os, Ir and Au or a binary alloy that is formed from the noble metals just mentioned.

### US PATENT DOCUMENTS

U.S. Pat. No. 5,275,998, January 1994, Tsurumi et al.

U.S. Pat. No. 5,350,727, September 1994, Tsurumi et al.

### FIELD OF THE INVENTION

This invention relates to a new type of catalysts that catalyze water gas shift reaction (WGSR) for hydrogen production and carbon monoxide reduction.

### BACKGROUND OF THE INVENTION

Carbon monoxide can be converted into carbon dioxide with additional hydrogen by reaction with steam according to the following equation

CO+H₂O=CO₂+H₂

This reaction is termed the water-gas shift reaction (WGSR). This reaction is one of steps in modern ammonia synthesis process. Ammonia is synthesized using H₂ and N₂ under high temperature and high pressure in the presence of a catalyst. Because H₂ does not occur naturally, it must be produced through industrial processes. In modern ammonia industry, H₂ is produced by reforming hydrocarbons such as natural gas with steam at high temperatures such as 600-900° C. The products after the reforming reaction contain carbon monoxide, carbon dioxide, and hydrogen. The carbon monoxide concentration can be more than 10%, depending on the type of hydrocarbons. Such a high carbon monoxide concentration is not only intolerable by the following ammonia synthesis catalyst, but also causes a large loss of raw material because of incomplete conversion to H₂. Therefore, water gas shift reaction is used to lower the carbon monoxide level and increase the yield of hydrogen. The water gas shift reaction is usually carried out in two stages. In the first stage, a reactor packed with iron oxide/chrome oxide catalyst is operated in a temperature range of 300-450° C. and carbon monoxide concentration is decreased from more than 10% to 2˜4%. In the second stage, another reactor packed with copper/zinc oxide/aluminum oxide (Cu/ZnO/Al₂O₃) is operated in a lower temperature range, typically 160-250° C., and CO concentration after this stage is further decreased to <1%. According to their operating temperature, the iron oxide/chrome oxide catalyst and the copper/zinc oxide/aluminum oxide catalyst are referred to as the high temperature shift (HTS) catalyst and low temperature shift (LTS) catalyst, respectively.

Proton exchange membrane (PEM) fuel cells also use H₂ as fuel to generate electricity. With the increasing demand for clean energy, fuel cells become more and more important. As energy converters, PEM fuel cells have many important advantages over conventional heat engines that are widely used in motor vehicles and fossil-fuel power plants. Conventional heat engines are limited thermodynamically in efficiency to less than 40% and release large amount of greenhouse gases. PEM fuel cells do not suffer from the limitation of thermodynamic efficiency, have much lower emissions of any pollutants to the environment, and their high efficiency reduces the release of greenhouse gases. One of major obstacles for the applications of PEM fuel cells is the source of hydrogen. Hydrogen storage devices such as tanks or metal hydrides may be used to store hydrogen. However, storage of gaseous hydrogen requires large volume to store practical amount of hydrogen, and storage of liquid hydrogen consumes power for liquefaction and requires high performance insulation. Metal hydrides have very low hydrogen storage capacity, typically 1.5% of metal weight. Generation of hydrogen from hydrocarbons by steam reforming is more practical as hydrogen sources. The process for hydrogen generation in a fuel cell system is very similar to the hydrogen generation process used in modern ammonia industry. First, a hydrocarbon is steam-reformed to produce a gas mixture of H₂/CO/CO₂, which is also called reformate. Depending on the fuel and the reforming process used, the CO content in the reformate may be more than 10% by volume. CO is a poison to fuel cell anodes. As little as 100 ppm CO can severely degrade the performance of proton exchange membrane fuel cells. Therefore, it is necessary to lower the CO concentration to trace levels. The current approach to decrease CO concentration includes two sequential steps: 1) water gas shift reaction, and 2) CO preferential oxidation. After water gas shift reaction, the CO concentration is lowered to ˜1%. The CO concentration is further decreased to <100 ppm after passing a CO preferential oxidation reactor, in which CO is preferentially oxidized using oxygen in the presence of a catalyst.

The current water gas shift reaction catalysts (iron oxide/chrome oxide and copper/zinc oxide/aluminum oxide) that are widely used in ammonia industry have several shortcomings for fuel cell applications. They need to be activated, e.g. reduction using hydrogen, to be active as catalysts. They are also sensitive to exposure to air. The requirement of activation causes great inconvenience, especially for transportation applications. Due to the highly on-off duty cycle, exposure of water gas shift reaction catalysts to air is inevitable. Therefore, development of alternate water gas shift catalysts that overcome the above shortcomings is important for the successful application of fuel cells in transportation.

It is an object of the present invention to provide water gas shift reaction catalysts that do not need activation.

A further object is to provide a water gas shift reaction catalysts that are not sensitive to exposure to air.

A particular object is to provide highly active water gas shift reaction catalysts that will significantly decrease the sizes of water gas shift reaction reactors.

### SUMMARY OF THE INVENTION

The present invention pertains to a new type of water gas shift reaction catalysts. A catalyst of this type comprises a catalyst support and two catalytically active components. The catalyst support can be chosen from, but not limited to, silicon oxide, aluminum oxide, or carbon power such as activated carbon or Vulcan-XC-72. The two catalytically active components are a metal oxide component and a metal component. The said metal oxide component is molybdenum oxide. The said metal component can be either a noble metal selected from Pt, Pd, Ru, Os, Ir and Au or a binary alloy that is formed from the noble metals just mentioned.

### BRIEF DESCRIPTION OF THE DRAWINGS

FIG. 1 shows carbon monoxide conversion at different operating temperatures over a water gas shift reaction catalyst (catalyst #1). The catalyst comprises 8.2% Pt, 17.6% molybdenum oxide, and 74.2% Vulcan-XC-72.

FIG. 2 shows carbon monoxide conversion at different flow rates at a constant temperature of 120° C. over a water gas shift reaction catalyst (catalyst #1). The catalyst comprised 8.2% Pt, 17.6% molybdenum oxide, and 74.2% Vulcan-XC-72.

FIG. 3 shows carbon monoxide conversion at different operating temperatures over a water gas shift reaction catalyst (catalyst #2). The catalyst comprises 1.6% Pt, 6.6% Pd, 17.6% molybdenum oxide, and 74.2% activated carbon.

FIG. 4 shows carbon monoxide conversion at different flow rates at a constant temperature of 120° C. over a water gas shift reaction catalyst (catalyst #2). The catalyst comprises 1.6% Pt, 6.6% Pd, 17.6% molybdenum oxide, and 74.2% activated carbon.

### DETAILED DESCRIPTION OF THE INVENTION

The present invention is a new type of water gas shift reaction catalysts. A catalyst of this type comprises a catalyst support and two catalytically active components. The catalyst support is a high surface area material, which can be chosen from, but not limited to, silicon oxide, aluminum oxide, or carbon power such as activated carbon or Vulcan-XC-72. The two catalytically active components, which are supported on the catalyst support, are a metal oxide component and a metal component. The said metal oxide component is molybdenum oxide. The said metal component can be either a noble metal selected from Pt, Pd, Ru, Os, Ir and Au or a binary alloy that is formed from the noble metals just mentioned. Molybdenum has different forms of oxides. Although the detailed mechanism is still not understood, it is speculated that molybdenum oxides change between different states in the catalytic process. Therefore, any forms of molybdenum oxides can be used as the oxide component of a water gas shift reaction catalyst. When a single noble metal is used as the metal component of a water gas shift reaction catalyst, platinum is the preferred choice. If an alloy is chosen as the metal component of a water gas shift reaction catalyst, PtPd alloy can be considered as the first preference. The content of the metal component in a water gas shift reaction catalyst varies, depending on the application requirements. It can be as low as 0.001% by weight or as high as more than 10% by weight. Likewise, the content of the metal oxide component in a water gas shift reaction catalyst can have a wide range, from a few percent to more than 90%. The function of the catalyst support is to improve the utilization of the two catalytically active components and to increase the resistance of the catalysts to thermal sintering. Although a catalyst support is always highly recommended, the combination of the two catalytically active components without a catalyst support always has catalytic activity for water gas shift reaction. Therefore, the weight percentage of the catalyst support in a water gas shift reaction catalyst can vary from 0% to more than 90%.

A method of supporting the two catalytically active components on the catalyst support is not especially restricted. The metal component can be put on the support in many ways. Conventional methods such as impregnation/H₂ reduction and reduction of a metal compound from a solution using a reducing agent can be used to support the metal component on the catalyst support. U.S. Pat. Nos. 5,275,998 and 5,350,727 have detailed description of preparing high surface area noble metal materials. The metal oxide component may be supported on the catalyst support by decomposing an ammonium salt of molybdate. Any other methods that produce small particles of molybdenum oxides can also be applied.

### EXAMPLES

The invention is illustrated in but not limited to the following examples.

### Example 1

A water gas shift reaction catalyst (catalyst #1) containing 8.2% Pt, 17.6% molybdenum oxide, and 74.2% Vulcan-XC-72 was prepared: It was tested using a tubular reactor. The catalyst weight was 0.74 g. A gas mixture of 1% CO in H₂ was first humidified by passing it through a water bottle at 100° C. The humidified 1% CO/H₂ gas mixture then entered the reactor. After all water was condensed, the reaction products of water gas shift reaction were analyzed using a gas chromatograph (HP 5890) that was equipped with a column of carbosphere 1000 and a thermal conductivity detector. Because of good catalytic activity, this catalyst catalyzed water gas shift reaction at such low temperatures as 100-130° C., which is significantly lower than 200° C., the typical operating temperature of the conventional low temperature water gas shift reaction catalyst (Cu/ZnO/Al₂O₃).

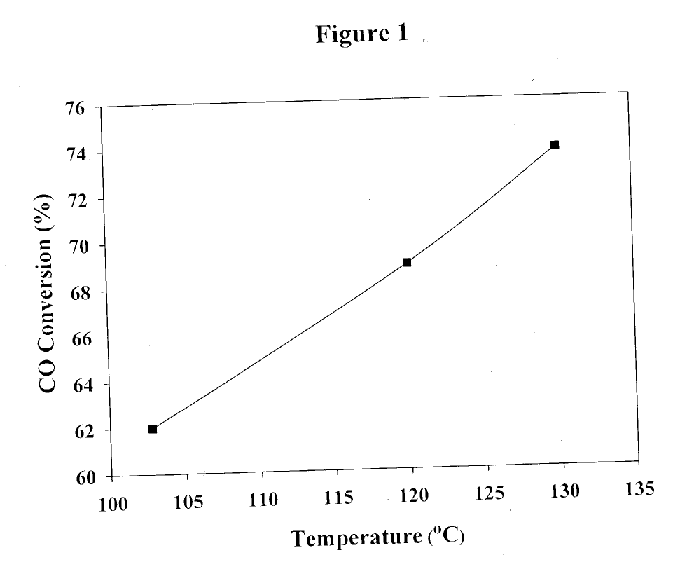

FIG. 1 shows carbon monoxide conversion at different temperatures at a constant flow rate of 140 ml/min (dry base). At a temperature of 100° C., 62% carbon monoxide was converted to carbon dioxide. When temperature was increased to 130° C., the carbon monoxide conversion was improved to 74%.

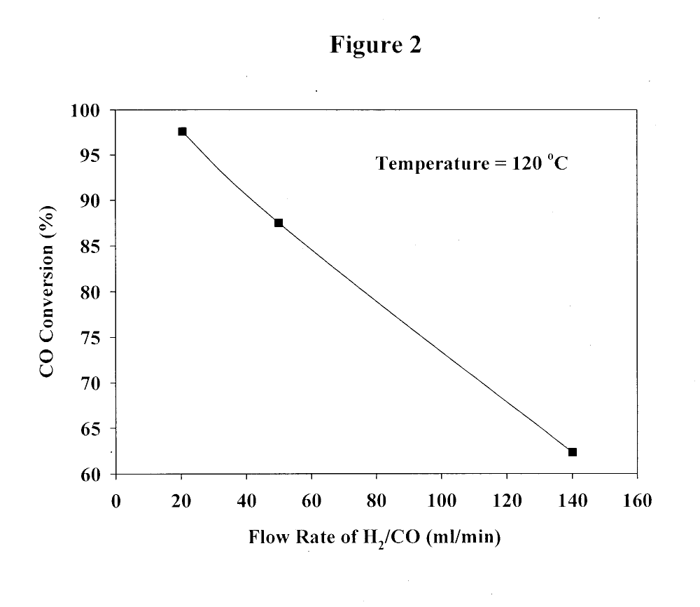

FIG. 2 shows carbon monoxide conversion at different flow rates (dry base) at a constant temperature of 120° C. At a flow rate of 140 ml/min, carbon monoxide conversion was 62%. When flow rate was decreased to 20 ml/min, 98% carbon monoxide was converted to carbon dioxide.

The effect of exposure to air on the catalyst activity was also tested. After the first test, the catalyst was taken out the reactor and stored in a bottle. Two weeks later, the catalyst was tested again. The carbon monoxide conversions for the first and second tests under the conditions of 120° C. and 140 ml/min were 68% and 62.3%, respectively. If we consider the experimental errors and the catalyst loss during catalyst transferring out of and into the reactor, the two conversions can be thought of quite the same. The almost same carbon monoxide conversions for both tests indicate that this catalyst has very good stability and that exposure to air does not affect its catalytic activity.

### Example 2

A water gas shift reaction catalyst (catalyst #2) containing 1.6% Pt, 6.6% Pd, 17.6% molybdenum oxide, and 74.2% activated carbon was prepared. 0.745 g of the catalyst was tested using a tubular reactor. A gas mixture of 1% CO in H₂ was first humidified by passing it through a water bottle at 100° C. The humidified 1% CO/H₂ gas mixture then entered the reactor at 120° C. The products of water gas shift reaction were analyzed using a gas chromatograph (HP 5890) that was equipped with a column of carbosphere 1000 and a thermal conductivity detector. The good catalytic activity of catalyst #2 for water gas shift reaction was demonstrated by its ability to convert carbon monoxide to carbon dioxide at such low operating temperatures as 100-120° C.

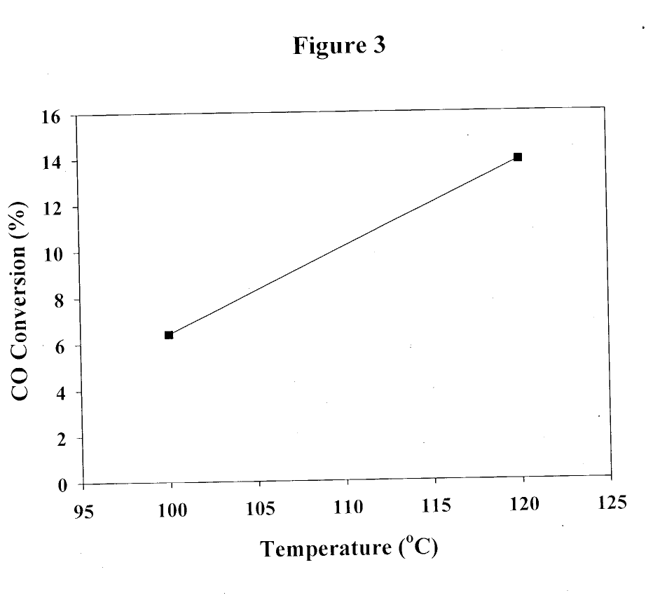

FIG. 3 shows carbon monoxide conversion at different temperatures at a constant flow rate of 144 ml/min (dry base). At a temperature of 100° C., 6.4% carbon monoxide was converted to carbon dioxide. When temperature was increased to 120° C., the carbon monoxide conversion was improved to 13.9%.

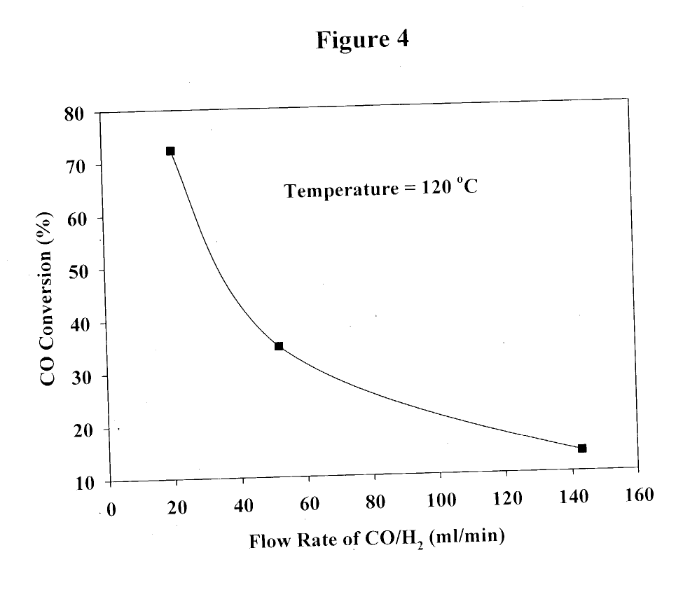

FIG. 4 shows carbon monoxide conversion at different flow rates (dry base) at a constant temperature of 120° C. At a flow rate of 144 ml/min, carbon monoxide conversion was 13.9%. When flow rate was decreased to 20 ml/min, 72.4% carbon monoxide was converted to carbon dioxide.

What is claimed is:

1) A new type of catalysts that catalyze water gas shift reaction.
a) The said water gas shift reaction means the following reaction:
CO+H₂O═CO₂+H₂
b) A catalyst of this type comprises a catalyst support and two catalytically active components.
c) The catalyst support is a high surface area material, which can be chosen from, but not limited to, silicon oxide, aluminum oxide, or carbon power such as activated carbon or Vulcan-XC-72.
d) The two catalytically active components, which are supported on the catalyst support, are a metal oxide component and a metal component.
e) The said metal oxide component is molybdenum oxide. Molybdenum has different forms of oxides. Any forms of molybdenum oxides can be used as the oxide component.
f) The said metal component can be either a noble metal selected from Pt, Pd, Ru, Os, Ir and Au or a binary alloy that is formed from the noble metals just mentioned.
g) The content of the metal component in the catalysts of this invention varies, depending on the application requirement. It can be as low as 0.001% by weight or as high as more than 10% by weight. Likewise, the content of the metal oxide component can have a wide range from a few percent to more than 90%. The weight percentage of the support in the catalysts of this invention can vary from 0% to more than 90%.
